(19) United States
(12) Patent Application Publication
(10) Pub. No.: US 2026/0349500 A1
(43) Pub. Date: Nov. 5, 2026

(54) WEARABLE DEVICE WEAR STATE DETERMINATION

(71) Applicant: GOOGLE LLC., Mountain View, CA (US)

(72) Inventor: Dongeek Shin, San Jose, CA (US)

(21) Appl. No.: 19/662,941

(22) Filed: Apr. 29, 2026

Related U.S. Application Data
(60) Provisional application No. 63/797,347, filed on Apr. 30, 2025.

(51) Int. Cl. G06F 3/01; G06F 1/3231

(52) U.S. Cl. CPC G06F 3/011; G06F 1/3231

(57) ABSTRACT

A system and method for determining a wear state of a wearable device utilize a temporal convolutional network to improve classification accuracy and power efficiency. The system receives a sequence of sensor data from one or more sensors and processes the data using a sliding time window to identify historical temporal trends. To comply with the memory and processing constraints of a wearable device, the model employs a hierarchical feature consolidation mechanism that applies a recency bias, where historical data is compressed more aggressively than recent data within the sliding window. This architectural tuning reduces computational complexity while maintaining high-fidelity context for distinguishing between actual wear events and false positives. Based on the generated state, the device dynamically adjusts its operational mode between active and standby states to optimize battery life.

### CROSS-REFERENCE TO RELATED APPLICATION

This application claims priority to U.S. Provisional Patent Application No. 63/797,347, filed on Apr. 30, 2025, entitled “WEARABLE DEVICE WEAR STATE DETERMINATION”, the disclosure of which is incorporated by reference herein in its entirety.

### BACKGROUND

For most wearable computing devices, it is important to know when the wearable device is being worn by a user and when the wearable device is not being worn by the user. For example, determining the device ON (DON) and/or device OFF (DOFF) state may help decide when to power or activate certain parts of the device, which can affect power consumption, battery life, and user experience.

### SUMMARY

Systems and techniques are described for providing a model that determines whether a wearable device is being worn by a user. It is important for wearable devices to be lightweight and to not increase the costs associated with manufacturing wearable devices. The systems and techniques disclosed herein enable accurate determination of whether a wearable device is being worn by a user by utilizing one or very few cost-effective sensors. The sensors may include proximity sensors and other existing sensors. The proximity sensor(s) may be sparse and/or inexpensive, thus reducing the costs associated with determining whether the wearable device is being worn.

The model used for determining whether a wearable device is being worn may be configured to receive and process data over a given time period. The time period may be large enough to allow the model to examine historical trends relating to the manner in which users wear the wearable device in order to more accurately determine whether the wearable device is being worn by a user. Moreover, to ensure that the model is lightweight, a compression mechanism may be applied to the model to compress the feature vectors within a sliding time period in the layers of the model. This results in a lightweight model that complies with the memory and processing constraints of a wearable computing device and can be executed locally on the device.

The details of one or more implementations are set forth in the accompanying drawings and the description below. Other features will be apparent from the description and drawings, and from the claims.

### BRIEF DESCRIPTION OF THE DRAWINGS

FIG. 1A depicts an example head-wearable device worn by a user, according to an aspect.

FIG. 1B depicts a front view, and FIG. 1C depicts a rear view of the head-wearable device shown in FIG. 1A, according to an aspect.

FIG. 2 is a block diagram of some components of a wearable device, according to an aspect.

FIG. 3 depicts a wearable device state diagram, in accordance with an aspect.

FIG. 4A depicts a diagram for a DON/DOFF determination model according to an aspect.

FIG. 4B depicts a diagram for training a DON/DOFF determination model, according to an aspect.

FIG. 5 depicts example graphs illustrating DON/DOFF state determination results according to an aspect.

FIG. 6 depicts a flowchart of a method for determining whether a wearable device is being worn by a user, according to an aspect.

### DETAILED DESCRIPTION

Wearable device wear state determination implementations are described herein. To ensure a seamless user experience and optimize power efficiency, wearable computing devices often need to accurately detect when they are being donned or doffed. Traditional threshold-based filtering methods often struggle with accuracy, frequently triggering false positives during common actions like folding the arms of smart glasses or moving a device without wearing it. The implementations described herein address these technical problems by utilizing a lightweight model that analyses sensor data over extended time windows to identify historical trends and patterns. By processing multi-dimensional signals from inexpensive or sparse sensors through a lightweight, local model that employs rapid feature compression and/or strided convolutions, the system provides a robust and low-latency technical solution for reliable wear detection on resource-constrained devices. The term sparse sensors as used herein refers generally to a reduced or minimal set of sensing components, often consisting of only one or two inexpensive sensors, used to provide input data for the state determination model.

Many wearable devices automatically turn off at least some features when the device is not being worn by a user. This may be done to conserve battery life and bandwidth resources. As a result, when the device is worn again, the user may have to manually provide an input indicating that the device is worn to turn on the features. To prevent this, some wearable devices use mechanisms to determine when a wearable device is worn on the body of a user. The state of when the wearable device is being worn by the user is referred to herein as a DON/DOFF state. For example, when the wearable device is in a DON state, the wearable device is being worn by a user. In a DOFF state, the wearable device is not being worn by a user.

Traditional techniques for determining DON/DOFF states often rely on data received from proximity sensors and then use a filter and/or a threshold to determine whether the sensor data indicates a specific wear state. This can lead to high rates of inaccuracy because data from proximity sensors can be misleading. This is particularly true with changes in proximity of the proximity sensor to a user’s body in various scenarios. For example, when a user is folding the arms of smart glasses, the proximity sensors may sense proximity to a person. This may result in an inaccurate DON state determination. Thus, existing techniques suffer from the technical problems of inaccurate DON/DOFF state determinations.

Inaccurate determination of the DON/DOFF state can affect multiple other wearable device characteristics and aspects, including power consumption, battery life, and user experience. Thus, an inaccurate DON/DOFF state determination can lead to many technical problems, such as the screen turning on when the device is not being worn, which may result in lower battery life, or the device not responding to user input (e.g., not counting steps) when the device is being worn. To increase accuracy, some existing techniques utilize several proximity sensors. Other techniques utilize more expensive sensors or a variety of sensors. These techniques result in problems, such as additional costs and/or adding extra weight to the wearable device.

The technical solutions described herein provide a more accurate determination of the DON/DOFF state, with fewer sensors. The technical solutions implement a model for DON/DOFF state determination that can receive data from sparse and/or already available sensors and accurately determine whether the device is being worn. The sensors may include proximity sensors and/or other sensors that already exist on a wearable device (e.g., for other reasons). The sensors may be sparse and/or inexpensive, thus reducing the costs associated with the DON/DOFF state determination. The model may include a temporal network that is configured to receive and process data from a sliding time window. The sliding time window may be large enough to allow the model to examine historical trends in order to more accurately determine the DON/DOFF state. Moreover, to ensure that the resulting model is lightweight, an effective level of compression may be applied to the model to rapidly compress feature vectors in the time window in the layers of the network. This provides the technical advantage of generating a lightweight model that complies with the memory and processing constraints of a wearable computing device, and can be executed locally on the device.

In some implementations, the stride in the convolution layer of the neural network is designed to capture historical trends of the DON/DOFF states. As a result, the technical solution provides increased accuracy as the model has access to more information instead of a simple thresholding scheme. The training of the model may be updated for a given user by using feedback mechanisms, such as user interactions with the wearable device, to determine the accuracy of the predictions and fine-tune the model to improve its accuracy for a given user.

In some implementations, the technical solutions disclosed herein address the technical problems of inaccurate wear detection by utilizing a neural-network-based approach that shifts away from simple instantaneous thresholding toward a temporal analysis of sensor data. For example, the system may implement a temporal convolutional network (TCN) configured to receive and process multidimensional signals from one or more sensors over a sliding time window. By analyzing historical trends and patterns within this window, rather than relying on isolated data points, the model can distinguish between actual wear events and misleading signals caused by common user actions, such as folding the arms of smart glasses or moving the device while it is not being worn.

The technical solutions further address the constraints of wearable hardware by employing a lightweight model architecture designed for local execution. This may be achieved through a rapid feature compression mechanism and/or numerical quantization within the neural network layers, which effectively shrink the time window as data propagates through the model. For example, the model may utilize 8-bit quantization for network weights and 16-bit quantization for activations, significantly reducing the memory footprint to fit within a microcontroller unit (MCU) having approximately 2 MB of RAM storage space. This design allows the system to capture long-term temporal dependencies needed for accuracy while maintaining a small memory and processing footprint compatible with an MCU. Furthermore, the model can be configured as a multimodal framework, stacking multiple sensor channels at the input layer to integrate data from diverse sources, such as proximity sensors, inertial measurement units (IMUs), and capacitive sensors, into a single, robust classification decision.

The technical effects of these technical solutions include a significant improvement in the accuracy and reliability of wear detection. By utilizing a model that accounts for historical sensor trends, the system achieves higher precision and recall compared to traditional filter-based methods, particularly in corner-case scenarios that typically trigger false positives. This improved accuracy ensures that device features are activated only when intended, directly enhancing the user experience by providing a seamless, always-ready interaction and preventing the device from being unresponsive when worn.

Another advantageous technical effect is the optimization of power efficiency and system resources. Because the model provides reliable detection using sparse or inexpensive sensors already present on the device, it eliminates the need for additional, high-cost, or power-hungry hardware. The ability to execute the lightweight model locally and on low-power secondary processors allows the primary system components to remain in a deep standby mode for longer periods, significantly extending battery life without sacrificing the speed of the wake-on-wear response.

The technology described herein has broad practical applications across the wearable electronics industry. One primary application is in the field of smart eyewear, such as AR or XR glasses. In these devices, the implementations disclosed herein can be used to automatically activate head-mounted displays, optical engines, and gaze-tracking systems the moment the user dons the frames, while ensuring these power-intensive components remain deactivated during handling or storage, even when the arms are unfolded. This ensures the device is ready for use immediately upon being placed on the face, facilitating a more natural and immersive interface.

Beyond eyewear, the invention is highly applicable to other body-worn form factors such as smartwatches, fitness trackers, and hearables like earbuds or over-ear headphones. For instance, a smartwatch could use this temporal model to more accurately gate health monitoring and step-counting features, ensuring that data collection only occurs during valid wear periods. In hearables, the system can manage automatic play and/or pause functionality and active noise cancellation settings based on a robust determination of whether the device is currently in or on the ear. Additionally, the framework's ability to be fine-tuned locally based on user interactions allows for personalized wear detection that adapts to the specific physiological characteristics and usage habits of an individual user over time.

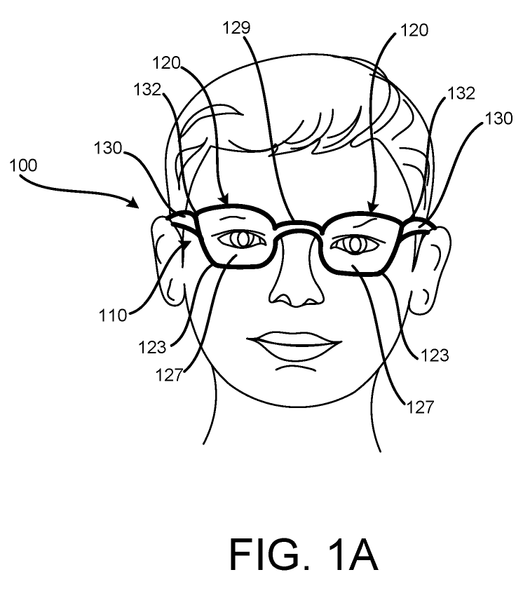

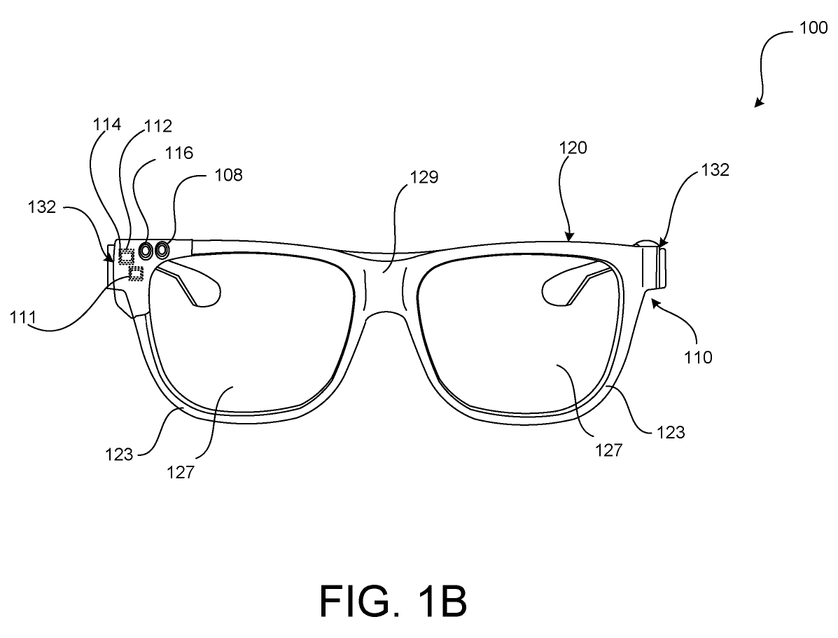

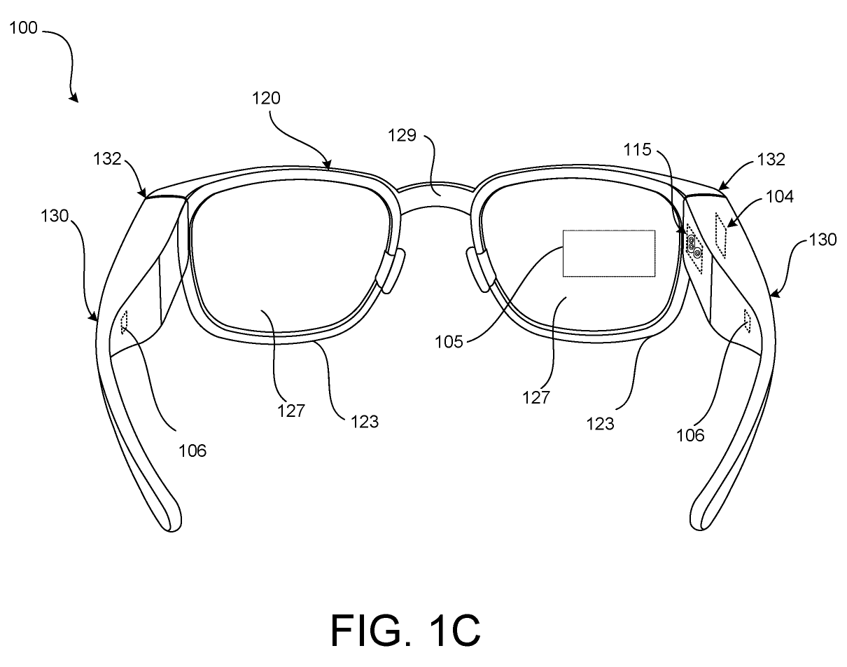

FIG. 1A depicts an example head-wearable device worn by a user, according to an aspect. FIG. 1B is a front view, and FIG. 1C is a rear view, of the example head-wearable device 100 shown in FIG. 1A. The head-wearable device 100 includes models which may be configured to classify one or more sensor inputs to determine an activity state of a head-wearable device. For example, one or more models of the head-wearable device 100 may be trained to identify a DON/DOFF state of the head-wearable device 100.

The example head-wearable device 100 is worn by the user 102 and includes a frame 110. The frame 110 includes a front frame portion 120, and a pair of arm portions 130 rotatably coupled to the front frame portion 120 by respective hinge portions 132. The front frame portion 120 includes rim portions 123 surrounding respective optical portions in the form of lenses 127, with a bridge portion 129 connecting the rim portions 123. The arm portions 130 are coupled, for example, pivotably or rotatably coupled, to the front frame portion 120 at peripheral portions of the respective rim portions 123. In some examples, the lenses 127 are corrective/prescription lenses. In some examples, the lenses 127 are an optical material including glass and/or plastic portions that do not necessarily incorporate corrective/prescription parameters.

A wearable device as used herein refers generally to any computing device that can be worn by a person. In some examples, the wearable device includes head-wearable devices such as smart glasses. In other examples, the wearable device includes earbuds. In some examples, the wearable device includes over-ear headphones. In yet other examples, the wearable device includes goggles (e.g., virtual reality (VR) goggles, augmented reality (AR) goggles or extended reality (XR) goggles). Thus, while this document describes and illustrates smart glasses style wearable devices, it is understood that a wearable device may include other body-worn devices such as, for example, earbuds, over-ear headphones, goggles, a smart headband, a smart earring, a smart watch, or any other device that is worn and active on a user’s body.

In some examples, the head-wearable device 100 includes a device display 104 that can output visual content, for example, at an output coupler 105, so that the visual content is visible to the user. In the example shown in FIGS. 1B and 1C, the device display 104 is provided in one of the two arm portions 130, simply for purposes of discussion and illustration. Device displays 104 may be provided in each of the two arm portions 130 for binocular output of content. In some examples, the device display 104 may be a see-through near-eye display. In some implementations, the device display 104 may be configured to project light from a display source onto a portion of teleprompter glass functioning as a beamsplitter seated at an angle (e.g., 30-45 degrees). The beamsplitter may allow for reflection and transmission values that enable the light from the display source to be partially reflected while the remaining light is transmitted through. Such an optic design may allow a user to see both physical items in the world, for example, through the lenses 127, next to content (for example, digital images, user interface elements, virtual content, and the like) output by the device display 104. In some implementations, waveguide optics may be used to depict content on the device display 104.

In some examples, the head-wearable device 100 includes one or more of an audio output device 106 (such as, for example, one or more speakers), an illumination device 108, a sensing system 111, a control system 112, at least one processor 114, and an outward-facing image sensor or camera 116. In some examples, the sensing system 111 may include various sensing devices and the control system 112 may include various control system devices including, for example, at least one processor 114 operably coupled to other components of the control system 112. In some examples, the control system 112 may include a communication module providing for communication and exchange of information between the head-wearable device 100 and external devices.

The sensing system 111 may include one or more capacitive touch sensors. The capacitive touch sensors may be located on one or both of the temple arm portions 130. In some examples, two capacitive touch sensors may be disposed in one of the temple arm portions 130. In some examples, one or more capacitive touch sensors may be located on other portions of the frame 110.

The sensing system 111 may also include a motion sensor, which may be implemented as an accelerometer, a gyroscope, and/or magnetometer, some of which may be combined to form an IMU. In some examples, the motion sensor may be implemented as a three-axis motion sensor such as, for example, a three-axis accelerometer or a three-axis gyroscope, where the motion signals captured by the motion sensor describe three translation movements (i.e., x-direction, y-direction, and z-direction) along axes of a world coordinate system. In some examples, the motion sensor may be implemented as a six-axis motion sensor such as, for example, an IMU that has six (6) degrees of freedom (6-DOF), which can describe three translation movements (i.e., x-direction, y-direction, and z-direction) along axes of a world coordinate system and three rotation movements (i.e., pitch, yaw, roll) about the axes of the world coordinate system.

The sensing system 111 may also include one or more proximity sensors. In some examples, the proximity sensors are optical proximity sensors. The proximity sensors may be located on one or both of the temple arm portions 130. In other examples, the proximity sensors are located on other portions of the frame 110. In some examples, the proximity sensors are off-the-shelf and/or inexpensive proximity sensors.

In some implementations, the head-wearable device 100 includes a gaze tracking device 115 to detect and track eye gaze direction and movement. Data captured by the gaze tracking device 115 may be processed to detect and track gaze direction and movement as a user input. In the example shown in FIGS. 1B and 1C, the gaze tracking device 115 is provided in one of the two arm portions 130, simply for purposes of discussion and illustration. In the example arrangement shown in FIGS. 1B and 1C, the gaze tracking device 115 is provided in the same arm portion 130 as the device display 104, so that user eye gaze can be tracked not only with respect to objects in the physical environment, but also with respect to the content output for display by the device display 104. In some examples, gaze tracking devices 115 may be provided in each of the two arm portions 130 to provide for gaze tracking of each of the two eyes of the user. In some examples, device displays 104 may be provided in each of the two arm portions 130 to provide for binocular display of visual content.

The control system 112 may include one or more models such as, for example, one or more machine learning models that are executed locally by processor 114. In some implementations, the models may be trained to classify one or more sensor inputs to determine an activity state of a head-wearable device. For example, one or more models of the control system 112 may be trained to identify a DON/DOFF state of the head-wearable device 100. The term DON/DOFF state as used herein refers generally to a classification of whether a wearable device is currently positioned on and supported by a user’s body in an operational manner or has been removed from the user’s body.

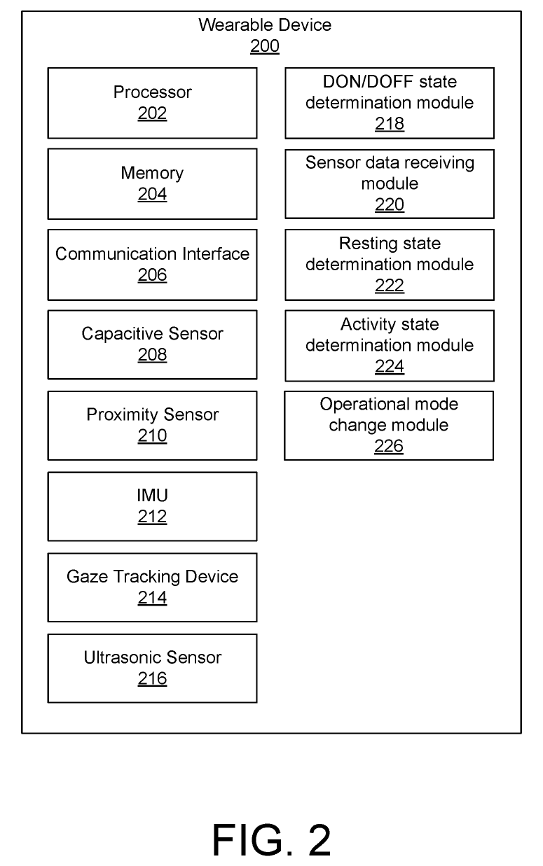

FIG. 2 depicts a block diagram of some components of a wearable device, in accordance with an example. The wearable device 200 may be the head-wearable device 100 of FIG. 1 or a different type of wearable device, such as, for example, a smart watch or earbuds. A head-wearable device may include any combination of elements described in FIGS. 1A-1C and FIG. 2.

The wearable device 200 includes a processor 202, memory 204, communication interface 206, one or more proximity sensors 210, and a DON/DOFF state determination module 218. In examples, the wearable device 200 may further include any combination of a capacitive sensor 208, an IMU 212, a gaze tracking device 214, and/or an ultrasonic sensor 216.

Head-wearable device 100 may include a sensor data receiving module 220 which may receive and process sensor data from one or more sensors. For example, the sensor data receiving module 220 may receive data from any combination of the capacitive sensor 208, proximity sensor 210, IMU 212, gaze tracking device 214, and ultrasonic sensor 216. As discussed above, one example of a sensor includes a capacitive touch sensor that outputs capacitive readings when near contact to the human temple (head) or skin. Another example of a sensor includes an optical proximity sensor that uses reflective optical energy (or time of flight) to measure proximity. Typically, capacitive touch sensors and proximity sensors use low power consumption, which provides the technical advantage of saving power on the wearable device 200 when the device is in DOFF mode but is still monitoring for the DON mode. The sensor data receiving module 220 may receive and preprocess the sensor data before transmitting the data to an appropriate module (e.g., DON/DOFF state determination module 218) for further processing.

The wearable device 200 may further include a resting state determination module 222. The resting state determination module 222 may use the sensor data to determine that the wearable device 200 is in a non-resting state. A non-resting state may refer to any circumstances in which a wearable device is either being moved or it is being worn (e.g., DON state). For example, a non-resting state may include circumstances where the wearable device 200 is being moved by a user, held by a user, or worn in an operational position. In examples, the wearable device may be carried in a backpack, in a moving car, or in the hand of a user who has picked up the device from a resting position but has not placed it on their body yet. A non-resting state can be in a DOFF state or a DON state.

To determine the resting state, the resting state determination module 222 may use data from the capacitive sensor 208, proximity sensor 210, and/or IMU 212. For example, if data from the capacitive sensor 208 or proximity sensor 210 indicates that the wearable device 200 is in proximity to a person’s skin, the resting state determination module 222 may determine that the device is not in a resting state. Additionally, the resting state determination module 222 may determine that the wearable device 200 is not in a resting state when data from the IMU 212 indicates movement.

In some implementations, the resting state determination module 222 may use a model to determine the resting state based on sensor data. The model may be a machine learning model that is trained using supervised or semi-supervised training. In some examples, the model may comprise a multi-channel support vector machine. In examples where the resting state determination module 222 utilizes a machine learning model, a training set of data may be generated including negative data indicating that the wearable device 200 is not in a resting state and positive data indicating that the wearable device 200 is in a non-resting state. The training set of data may be generated by collecting sensor data associated with positive data from devices being carried or worn by users while performing a variety of daily tasks. Sensor data associated with negative data may be collected from devices that are substantially at rest on a stable surface.

In some implementations, data from one or more of the sensors, gaze tracking device, and/or processor 202 may be used by an activity state determination model 224 to determine that the wearable device 200 is in an active state. Active state is used herein to refer to a wearable device being actively used by a user. For example, when the user is interacting with a smart watch via the touch screen or interacting with a head-wearable device via a microphone or hand movements, the device is in an active state. The activity state determination module 224 may utilize machine learning models or classifiers to determine that the wearable device is in an active state.

Data from the resting state determination module 222 and/or the activity state determination module 224 may be used to fine-tune the models used by the DON/DOFF state module 218, as further discussed below. The resting state determination module 222 may generate an activity rating using sensor data as input and determine that the wearable device 200 is in an activity state based on the activity rating. In an example, the activity states may include a resting state and a non-resting state.

In some implementations, the processor 202 includes multiple processors, and memory 204 includes multiple memories. The processor 202 may be in communication with any cameras, sensors, and other modules and electronics of the wearable device 200. The processor 202 is configured by instructions (e.g., software, application, modules, etc.) to determine wearable state or execute any modules included on the wearable device 200. The instructions may include non-transitory computer-readable instructions stored in, and recalled from, memory 204. In examples, the instructions may be communicated to the processor 202 from a computing device or from a network (not pictured) via the communication interface 206. Moreover, the processor 202 may be in communication with the device display 104 of FIG. 1C. For example, the processor 202 may be configured by instructions to transmit text, graphics, video, images, etc. to the device display 104.

The communication interface 206 of wearable device 200 may be operable to facilitate communication between the wearable device 200 and other computing devices, such as desktop computers, laptop computers, tablet computers, smartphones, wearable computers, servers, or any other type of computing device. In some examples, the communication interface 206 utilizes Bluetooth, Wi-Fi, Zigbee, or any other wireless or wired communication methods to communicate with other devices.

In some implementations, the wearable device 200 also includes one or more capacitive sensors 208. The capacitive sensors 208 may determine when a surface with dielectric properties, such as a finger, comes in close proximity via a change in capacitance from two conductive surfaces. In some examples, the capacitive sensor 208 may be positioned on one or both of the temple arm portions 130, or on other portions of frame 110 of the wearable device 100 of FIGS. 1A-1C.

In addition to the capacitive sensors 208, the wearable device 200 may also include one or more proximity sensors 210. The proximity sensors 210 may determine the presence or absence of a surface, for example the temple of a head, by generating an electromagnetic field (for example, infrared) and detecting electromagnetic radiation reflected off that surface. Thus, the proximity sensors 210 can help determine if the wearable device 200 is in proximity to a user’s skin. In some examples, the proximity sensor 210 is positioned on one or both of the temple arm portions 130, or on other portions of frame 110 of the wearable device 100 of FIGS. 1A-1C.

In some implementations, the wearable device 200 also includes an IMU 212. The IMU 212 may include a motion sensor operating in one to three dimensions which may include any combination of accelerometer, gyroscope, and/or magnetometer. In some examples, the IMU 212 is implemented as a three-axis motion sensor such as, for example, a three-axis accelerometer or a three-axis gyroscope, where the motion signals captured by the motion sensor describe three translation movements (i.e., x-direction, y-direction, and z-direction) along axes of a world coordinate system. In other examples, the IMU 212 may be implemented as a six-axis motion sensor which can describe three translation movements (i.e., x-direction, y-direction, and z-direction) along axes of a world coordinate system and three rotation movements (i.e., pitch, yaw, roll) about the axes of the world coordinate system. In some implementations, the wearable device 200 may include more than one IMU 212.

The wearable device 200 may also include a gaze tracking device 214. The gaze tracking device 214 may recognize and track eye gaze direction and movement by imaging a user’s eye. This may involve the use of one or more cameras 116 of the wearable device 100 of FIG. 1B. In an example, the gaze tracking device 214 includes an electromagnetic radiation source to illuminate the eye(s) and a camera to image it.

In some implementations, the wearable device 200 may include one or more ultrasonic sensors 216. The ultrasonic sensors 216 may be microphones that can sense ultrasonic output from an audio output device such as the audio output device 106 of FIG. 1C. The ultrasonic sensors 216 and audio output device 106 may be used, for example, to generate a time-of-flight measurement to an object, such as a human head.

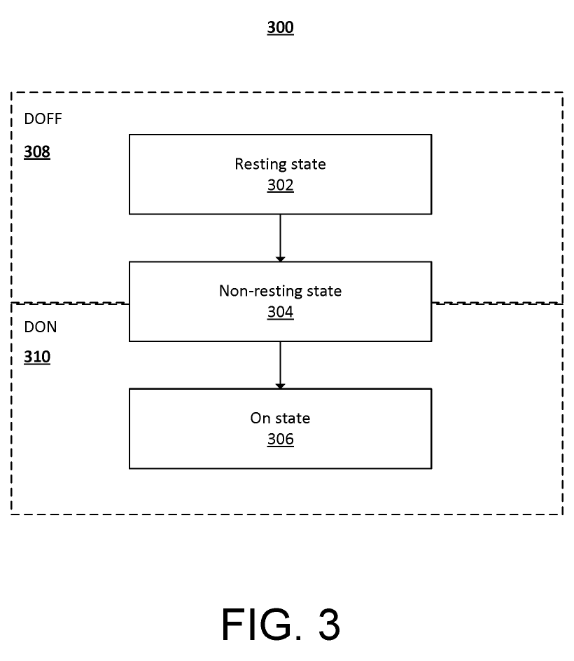

FIG. 3 depicts a wearable device state diagram 300, in accordance with an aspect. The state diagram 300 illustrates the relationship between a resting state, non-resting state, and on state and the correspondence of these states with DON/DOFF states. A wearable device is normally in a DOFF state 308 when it is in a resting state 302. In the resting state 302, the wearable device is not being worn on the body of a user and may be positioned on a substantially non-moving surface, such as a table. In some examples, the resting state 302 also means that the wearable device is not being touched or held by a user. In the resting state 302, the wearable device may be powered off, powered on, or charging.

The transition between a DOFF state 308 and a DON state 310 may include one or more intermediate activity states which may be determined based on one or more sensors. In the non-resting state 304, the wearable device is not in the resting state 302. As discussed above, this may involve the device being moved in a car or in a user’s bag, or being moved directly by the user (e.g., the user picks up the device from a charging station and is in the process of putting it on). As a result, the non-resting state may correspond with the DOFF state 308 or the DON state 310. Correctly identifying the DON/DOFF state when the device is in the non-resting state 304 is challenging for many existing technologies, because during the transition period the user may be holding the device. For example, the user may be folding the arms of smart glasses, or the user may be moving a smart watch from one location to another without putting the device on. In these circumstances, the capacitive, proximity, and/or IMU sensors are likely to indicate that the device is moving and/or is proximate to a person. As a result, solely relying on the sensor data may result in an inaccurate DON/DOFF state determination.

During the on state 306, the wearable device is being worn on the body of a user as it is designed to be operated. Accordingly, in the on state 306, the wearable device is in the DON state 310.

Referring back to FIG. 2, the wearable device 200 may include a DON/DOFF state determination module 218. The DON/DOFF state determination module 218 may generate, using sensor data as input, a state indicating whether the wearable device is being worn (e.g., whether the wearable device is in a DON state 310 or a DOFF state 308). In examples, the sensor data may include data received from one or more proximity sensors and/or one or more capacitive sensors. In other examples, the sensor data may also include data received from an IMU, an eye-tracking camera, or an ultrasonic sensor.

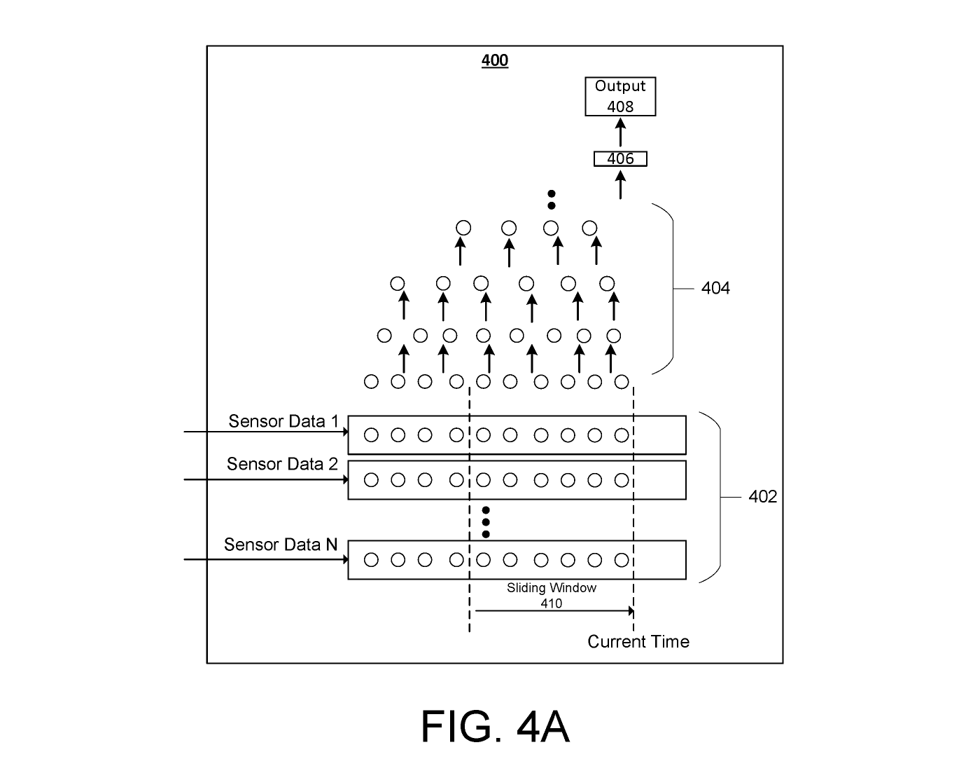

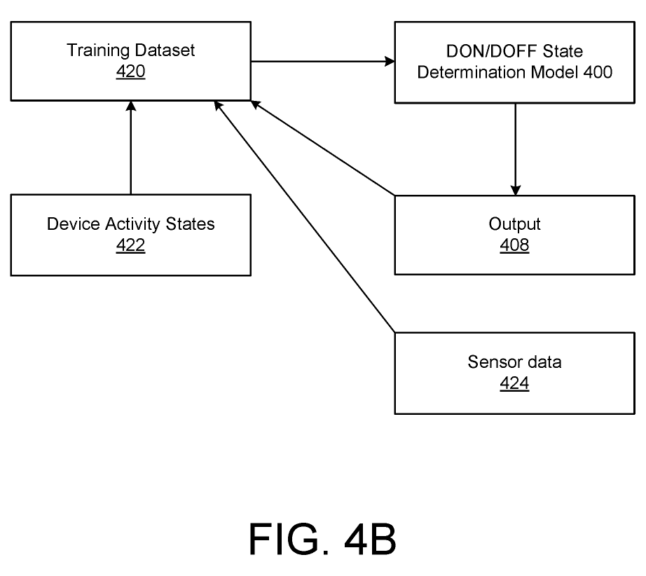

To accurately determine the DON/DOFF state, the DON/DOFF state determination module 218 may execute a model, such as a machine learning model. The machine learning model may receive sensor data from one or more proximity sensors (e.g., two proximity sensors) as input over a period of time and determine the DON/DOFF state based on examination of the data over time. In an example, the machine learning model includes a convolutional neural network (CNN). In addition to the sensor data, the machine learning model may utilize historical data, usage data, and/or predictive data associated with a user to determine the DON/DOFF state. Details of the machine-learning model are discussed in more detail with regards to FIG. 4A.

The wearable device 200 may also include an operational mode change module 226. In response to determining that the wearable device 200 is in the DON state 310, the operational mode change module 226 may determine a mode for operating the wearable device based on the state determined by the DON/DOFF state determination module 218. For example, based on determining that the wearable device is being worn, the operational mode change module 226 may change a mode of operating the wearable device 200 to an active operational mode. Furthermore, in response to determining that the wearable device is in a resting/DOFF state, the operational mode change module 226 may change the mode of operating the wearable device from an active mode to a standby mode.

An operational mode of the wearable device 200 may include one or more modes of software and/or hardware operations. For example, a first operational mode may be a standby mode (e.g., sleep mode) applied during a resting state and/or DOFF state of the wearable device 200. During the standby mode, components of the wearable device 200 may be minimally powered to conserve energy. In some examples, the sensors used to determine the DON/DOFF state may be powered, while the remaining sensors and/or the device display are not. This provides the technical advantage of conserving power and extending the battery life of the wearable device. By using the DON/DOFF state determination module 218, which utilizes an improved machine learning model to accurately identify DON/DOFF states and requires less sensor data, the wearable device can maintain more components in a sleep mode, thus conserving more power.

A further operational mode of the wearable device 200 may include an active mode (e.g., awake mode). Active mode may be applied in an on state of the wearable device 200. In active mode, power may be provided to both the processor 202, communication interface 206, sensors 208, 210, and 216, and additional components needed for normal operation of the wearable device 200, such as gaze tracking device 214 and IMU 212. In other examples, there may be additional operational modes. By accurately determining the DON/DOFF state, the operational mode change module 226 can correctly determine and set the appropriate operational mode for the wearable device 200, thus conserving power and increasing user satisfaction.

In some implementations, the processor 202 includes two processors: a first processor and a second processor. The first processor may be lower power/slower, and the second processor may be higher power/faster. In examples, the first processor may be configured to determine that the head-wearable device is in the DON/DOFF state, and the second processor may be configured to perform additional functions of the wearable device such as functions executed when the device is in an active operational mode. By dividing up the processing between the first and second processors, the wearable device may be able to optimize battery performance, accuracy, and speed of response to a user preparing to use the wearable device 200.

Some of these implementations can provide various technical advantages such as a significant improvement in the accuracy and reliability of wear detection. By utilizing a model that accounts for historical sensor trends and identifies patterns over a sliding time window, the system achieves higher precision and recall compared to traditional filter-based or instantaneous thresholding methods. This is particularly effective in corner-case scenarios, such as folding the arms of smart glasses or moving a device without donning it, which typically trigger false positives in conventional systems. The improved accuracy ensures that device features are activated only when intended, directly enhancing the user experience by providing a seamless, always-ready interaction and preventing the device from being unresponsive when worn.

FIG. 4A depicts a diagram for a DON/DOFF determination model 400 according to an aspect. In some implementations, the DON/DOFF determination model 400 is a temporal convolutional network (TCN) which is designed for sequencing time-series data. The term temporal convolutional network as used herein refers generally to a neural network architecture designed for processing sequence data using a convolutional structure that enables the model to capture dependencies and patterns over a span of time.

The DON/DOFF determination model 400 receives a series of sensor data 402 along a sliding time window 410. The term sliding time window as used herein refers generally to a fixed or variable duration of historical sensor data segments that are incrementally updated and used in a processing model to provide temporal context for a current determination. The series of sensor data 402 may be sequential data. The sensor data may include sensor data 1 through sensor data N. Sensor data 1 is data received from one sensor, while sensor data 2 refers to sensor data received from a second sensor, and so on. In some examples, some of the sensor data is received from proximity sensors, while some is received from IMUs, capacitive sensors, and/or other sensors. In some implementations, the sensor data 402 is a normalized sensor reading block in a sliding window fashion.

The DON/DOFF determination model 400 may incorporate a residual skip connection branching from an input layer and rejoining the processing path at a downstream summation layer (e.g., an addition layer). This skip connection allows the model to preserve raw signal characteristics while simultaneously extracting higher-level temporal features, facilitating faster convergence during training and maintaining signal integrity in a shallow network architecture compatible with resource-constrained hardware.

In some implementations, the DON/DOFF determination model 400 is able to provide accurate DON/DOFF determination with sensor data from one or two proximity sensors. In such implementations, additional sensor data is not received or used by the DON/DOFF determination model 400. This enables the DON/DOFF determination model 400 to remain lightweight and conserve computational overhead, thus conserving the amount of memory and processing resources needed to execute the model 400 on the wearable device.

In order to enable the DON/DOFF determination model 400 to process data from multiple sensors, the input layer of the DON/DOFF determination model 400 may include multiple channels. The multiple channels may receive data from different types of sensors (e.g., proximity and IMU). As such the DON/DOFF determination model 400 may be multimodal. Each channel of the input layer may go through its own convolutional operations to generate features. The features generated for the multiple channels are then combined in the final layers of the neural network for classification to generate an output.

The circles in each of the sensor data 402 boxes represent sensor data at a given timestamp. Thus, at a given current time, the DON/DOFF determination model 400 utilizes time-series datapoints from various previous timestamps within a sliding time window 410 as input to determine the DON/DOFF state of the device. The DON/DOFF determination model 400 receives the time series sensor data points as inputs and utilizes the neural network layers 404 to extract features of interest. The neural network layers 404 compress the feature vectors within the sliding time window 410 as the data moves through the layers. In order to increase efficiency while still providing accuracy, the neural network layers 404 may begin with a larger sliding time window 410 and compress the feature vectors such that the time window decreases in size at each layer. For example, the sliding time window 410 may be initially set to 30 seconds and may be decreased by 5 seconds at each layer to ensure that the number of layers remains small, thus resulting in a lightweight model that can be executed on the wearable device. In other examples, the sliding time window 410 may be set to an initial size of 10 seconds and the time window may be compressed by 2 seconds at each layer. In yet another example, the DON/DOFF determination model 400 receives a 50-frame sensor buffer data as input where look-ahead is minimal.

The neural network layers 404 extract features of interest at each layer to generate a feature vector. In some implementations, the layers employ a hierarchical design to incorporate a recency bias, where information closer to the current time is weighted more heavily. As data propagates through the layers, vectors representing older sensor data within the sliding time window 410 are consolidated or compressed more aggressively than vectors representing recent data. This results in a sparse distribution of data in the final layers where the past context becomes increasingly sparse, effectively reducing the computational load by avoiding unnecessary matrix multiplications on historical data points that have already been summarized into higher-level features.

The size of the sliding time window and the amount by which the window size is reduced may be adjusted based on the specifications and/or requirements of the wearable device (e.g., the amount of processing or memory resources available on the wearable device). Moreover, the size of the sliding time window and the amount by which the window size is reduced may be adjusted based on the recency of data. For example, data that is closer in time may be compressed by a smaller amount than data that is further away in time. In an example, a developer may determine the maximum amount of memory space available for the DON/DOFF determination model 400 on a given wearable device and adjust the size of the time window accordingly.

The adjustment to the size of the sliding time window may be referred to as the amount of compression or the level of compression. In some implementations, the compression amount is determined by a hardware-constrained optimization process. Specifically, a target memory footprint (e.g., 1 megabyte) of the microcontroller is converted into a required feature compression amount via a determined equation. The neural network architecture is then structurally modified to match this compression amount, ensuring the model's depth and feature map sizes are mathematically configured to fit within the local hardware constraints before training begins.

The term amount of compression or level of compression as used herein refers generally to the speed or degree at which the temporal dimensions (e.g., size of the sliding time window) or feature mappings of input data are reduced across successive layers of a neural network to minimize computational complexity. Compression of the feature mappings may refer to reducing the number of feature vectors by combining multiple features vectors such as that a feature vector at a higher layer of the network represents data from multiple feature vectors in a lower layer of the model. In some implementations, feature vectors from a time period within the sliding time window that is further away from the current time are combined into fewer feature vectors such that the size of the sliding time window can be reduced with a recency bias. For example, considering a sliding time window representing 60 seconds of sensor data initially represented by 60 individual feature vectors (one per second) at an input layer, as data propagates through successive layers, the model may consolidate the 30 vectors representing the oldest 30 seconds of data into a three, sparse feature vectors, each representing 10 seconds of the time window, while maintaining 30 distinct, dense feature vectors for the most recent 30 seconds of data. At the higher levels, 20 more feature vectors representing the next oldest time period may be consolidated into 2 vectors, and eventually the 5 vectors representing the oldest 50 seconds may be consolidated into a single vector. This hierarchical consolidation ensures that the peak of information density remains focused on the user's most recent actions, effectively reducing the computational load by avoiding quadratically increasing matrix multiplications on historical data points that have already been summarized into higher-level temporal features. In another example, considering a sliding time window representing 60 seconds of sensor data initially represented by 60 individual feature vectors (one per second) at an input layer, as data propagates through successive layers, the model may consolidate the 50 vectors representing the oldest 50 seconds of data into a single, sparse feature vectors, while consolidating the 10 vectors representing the most recent 10 seconds into three feature vectors.

The term compress as used herein generally refers to a hierarchical feature consolidation process within the neural network layers, wherein the temporal resolution of historical sensor data is reduced as it propagates through successive layers. This may involve mathematically consolidating a first plurality of feature vectors representing a past time period into a second, smaller plurality of feature vectors (e.g., consolidating 60 initial vectors representing 60 seconds of data into 5 final vectors). This process creates a distribution of data which is heavier on recent information, referred to herein as a recency bias, while past context becomes increasing sparse, thereby reducing computational complexity and matrix multiplications while maintaining a moving window of temporal context.

In some implementations, the DON/DOFF determination model 400 is configured with minimal look-ahead (e.g., utilizing a 50-frame buffer) to ensure that the detection of a wear event occurs substantially in real-time as the user is in the process of putting the device on. By biasing the temporal analysis toward historical data points within the window, the system minimizes the processing delay between the physical act of donning and the activation of device features.

The neural network layers 404 extract the features of interest at each layer to generate a feature vector 406 at a final layer. The feature vector 406 may then be used to encode the classification of the DON/DOFF state and generate the output 408. Encoding the classification may involve outputting a 3-node layer that encodes the classification as one of: a DON state, a DOFF state, or a NONE state. A NONE state may be generated as an output when the confidence level of the DON/DOFF classification is below a given threshold and the DON/DOFF determination model 400 is thus not confident about the accurate state of the device. In response to a NONE state, the operational mode change module 226 may maintain the current operational mode or, alternatively, increase the sampling rate of the sensors 210 to resolve the ambiguity while preventing a premature transition to a high-power active mode. The output 408 indicates a DON/DOFF state for the wearable device at the current time. The term NONE state as used herein refers generally to an output classification indicating that the state determination model has not achieved a confidence level above a predefined threshold to definitively classify the device as being in either a DON state or a DOFF state.

By using a temporal model that utilizes a longer time window of sensor data as input, the DON/DOFF determination model 400 is able to examine a longer time span of data in the past and, as such, identify patterns more accurately. Moreover, the striding of the convolutional layer of the neural network is designed to capture a historical trend of data associated with DON/DOFF states. Thus, the model 400 is configured to process data from other sensor(s) as well as usage data to generate the state for the wearable device. Because of this, the accuracy of the model increases as the model has access to more historical information instead of a simple thresholding scheme. Furthermore, the DON/DOFF determination model 400 utilizes aggressive augmentation through, for example, scaling and temporal shifting to produce a large dataset. By using such augmentation techniques, the DON/DOFF determination model 400 is able to perform well even for scenarios in which traditional DON/DOFF models cannot provide accurate results.

In some implementations, the model 400 is specifically architected to comply with the physical constraints of the wearable device hardware. In some examples, the compression amount of the neural network layers is mathematically derived from a predefined memory limit of the processor (e.g., a 2 MB RAM limit of a microcontroller). The system may utilize an optimization equation to convert the available memory footprint into a target feature compression amount. The network architecture is then structurally tuned to match this amount, ensuring the model is mathematically configured to fit within the local hardware constraints while maximizing the duration of the historical sensor data that can be analyzed within the sliding window.

FIG. 4B depicts a diagram for training a DON/DOFF determination model, according to an aspect. To provide initial training for the DON/DOFF determination model 400, a training dataset 420 may be generated and used to train the DON/DOFF determination model 400. The training dataset 420 may include negative data indicating that a wearable device is not in a DON state and positive data indicating that a wearable device is in a DON state. The training dataset 420 may be generated by collecting sensor data associated with a positive state over a long time period from devices being worn by users while performing a variety of daily tasks. Sensor data associated with a negative state is also collected from devices in a variety of other situations. The data may be labeled by using labels received from the users that wore the devices. The training dataset 420 can then be used to provide supervised training to the DON/DOFF determination model 400. This may be done offline before the model is deployed on the wearable device.

The training of the DON/DOFF determination model 400 may then be improved and customized per user once a user begins using the wearable device. In an example, data from device activity states 422, output 408 and/or sensor data 424 is collected to determine if the DON/DOFF determinations of the DON/DOFF determination model 400 are correct for the user. For example, this may include collecting activity states of the device within a given time window of determining that the device changed from a DOFF state to a DON state to see if any sensors indicate active use of the device. If there is no indication of active use within a threshold time period after the DON state determination, this may indicate that the DON state determination was incorrect. This data is collected and stored in the training dataset 420 to fine-tune and improve the DON/DOFF determination model 400, thus customizing it for a given user.

The training of the DON/DOFF determination model 400 may be refined through the use of a feedback loop that incorporates real-time user interactions with the wearable device. As discussed above, if the DON/DOFF determination model 400 determines a DON state and activates an operational mode, but the user does not engage with any device features (e.g., no touch inputs, gaze movements, or microphone activations are detected by the activity state determination module 224) within a threshold time period, the system may classify the prediction as a false positive. This negative feedback is utilized to adjust the model's weights locally. Conversely, explicit user actions, such as interacting with a touch-sensitive surface or providing a voice command immediately following a wear-state transition, serve as positive labels to reinforce the specific sensor patterns associated with that user’s physiology and wearing habits.

This personalization process allows the DON/DOFF determination model 400 to adapt to individual variations, such as the specific distance between a user's temple and the proximity sensors 210, or the unique temporal signature of how a specific user dons their glasses. Over time, the training dataset 420 is updated with these user-specific samples, and a fine-tuning operation is performed on the wearable device. Because the neural network layers 404 are compressed and lightweight, this local training can be executed during periods of low computational activity, such as when the device is in a charging state, ensuring that the DON/DOFF determination model 400 continuously improves its accuracy and reliability for the individual user without impacting the immediate responsiveness of the system.

Some of these implementations can provide various technical advantages such as a significant improvement in the accuracy and reliability of wear detection. By utilizing a model that accounts for historical sensor trends, the system achieves higher precision and recall compared to traditional filter-based methods, particularly in corner-case scenarios that typically trigger false positives. This improved accuracy ensures that device features are activated only when intended, directly enhancing the user experience by providing a seamless, always-ready interaction and preventing the device from being unresponsive when worn.

Another advantageous technical effect is the optimization of power efficiency and system resources. Because the model provides reliable detection using sparse or inexpensive sensors already present on the device, it eliminates the need for additional, high-cost, or power-hungry hardware. The ability to execute the lightweight model locally and on low-power secondary processors allows the primary system components to remain in a deep standby mode for longer periods, significantly extending battery life without sacrificing the speed of the wake-on-wear response.

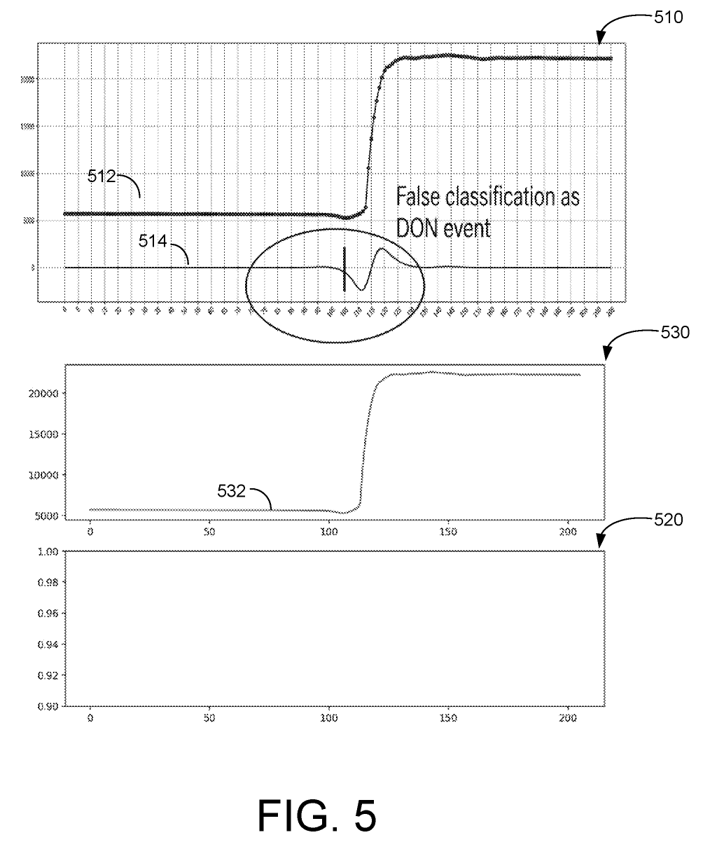

FIG. 5 depicts an example graph illustrating DON/DOFF state determination results obtained via a traditional technique and an example graph showing the results obtained via the DON/DOFF determination systems disclosed herein. The X axis in graphs 510, 520, and 530 represents time and the Y axis in graphs 510 and 530 represents the intensity of sensor data. Line 512 in graph 510 and line 532 in graph 530 show the sensor signal. As depicted, at a certain point in time, there is a significant increase in the intensity signal received from the sensor. When the sensor is a proximity sensor, this often occurs when the sensor detects proximity to a person’s body (e.g., skin, head, etc.). This can occur, for example, when smart glasses are placed on a user’s head. However, the change in sensor signal may also occur when a user is folding the arms of the glasses or when the user simply picks up the glasses to move them to a different place. Line 514 of graph 510 depicts how this change in sensor data would result in a false identification of a DON event in a traditional system. However, because the DON/DOFF determination system of this disclosure does not merely rely on the sensor data at a current time, but examines historical patterns, the disclosed DON/DOFF determination system is able to recognize the false sensor data indication and, as such, it does not generate an incorrect DON state, as depicted in graph 520. As a result, the disclosed DON/DOFF determination system can receive sensor input data from one or two inexpensive sensors and still provide accurate results, thus significantly improving the DON/DOFF determination accuracy and efficiency.

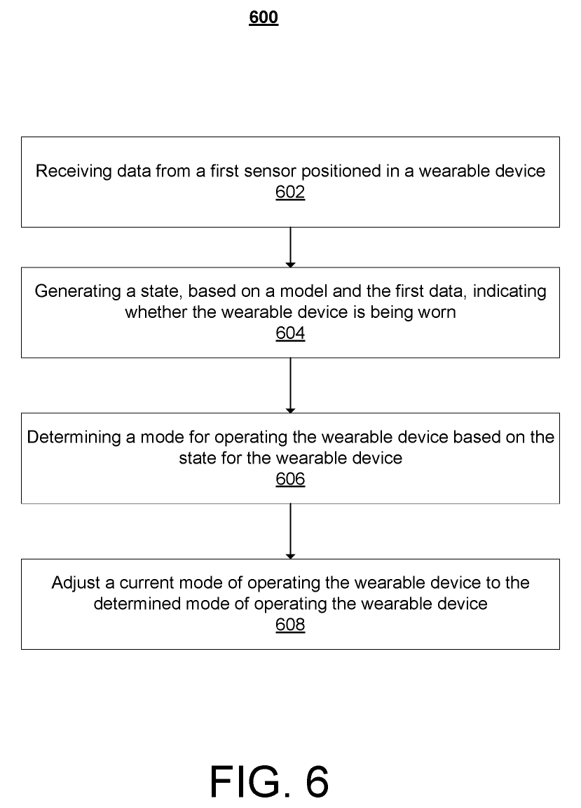

FIG. 6 is a flowchart depicting an example process 600, according to examples. Process 600 may be used to determine that a wearable device is being worn by a user. In some implementations, process 600 may be performed by a computing device, such as the head-wearable devices of FIG. 1A-1C and FIG. 2. In particular, process 600 may be performed by the DON/DOFF determination model 400. Although the process 600 of FIG. 6 is explained with respect to the DON/DOFF determination model 400 of FIG. 4A, the process 600 may be applicable to any of the implementations discussed herein. Moreover, although process 600 of FIG. 6 illustrates the operations in sequential order, it will be appreciated that this is merely an example, and that additional or alternative operations may be included. Further, operations of FIG. 6 and related operations may be executed in a different order than that shown, or in a parallel or overlapping fashion.

Process 600 begins with receiving data from a sensor positioned in a wearable device at step 602. The wearable device may be a device such as the head-wearable device 100 of FIGS. 1A-1C and/or the wearable device 200 of FIG. 2. The sensor may be a proximity sensor, capacitive sensor, or IMU sensor. In an example, the sensor is configured to provide an indication of the wearable device’s position with respect to a user.

After receiving the data from the sensor, process 600 may proceed to generate a state, based on a model and the received data, at step 604. The state indicates whether the wearable device is being worn. This may involve providing the data as an input to a model of the wearable device. The model may be a temporal model (e.g., neural network model) such as the DON/DOFF determination model 400 of FIG. 4A. The input to the model may be a time-series sensor data in a sliding time window. The model may be executed to generate the state for the wearable device. In an example, the model receives the data for a time window as input to a first layer of a model and compresses the feature vectors within the time window in subsequent layers of the model to reduce the number of layers of the model. The compression amount of the model may be determined based on the amount of processing and/or memory resources available on the wearable device for executing the model. The determined state may be one of a DON state, a DOFF state and a NONE state.

After generating the state, process 600 proceeds to determine a mode for operating the wearable device based on the state for the wearable device, at step 606. This may be done by examining the determined state to determine which mode of operation the determined state corresponds with. For example, the DOFF state may correspond with a standby mode, while the DON state corresponds with an awake mode.

In some implementations, process 600 proceeds to adjust a current mode of operating the device to the determined operational mode, at step 608. This may involve examining the determined DON/DOFF state, determining if the determined state is different from the current state of the wearable device and changing the current state when the determined state is different from the current state. For example, if the wearable device is in a standby mode and the wearable device is determined to be in a DON state, the operational mode may be changed to an awake mode.

Further to the descriptions above, a user may be provided with controls allowing the user to make an election as to both if and when systems, programs or features described herein may enable collection of user information (e.g., sensor data, device state data, or history data), and if the user is sent content or communications from a server. In addition, certain data may be treated in one or more ways before it is stored or used, so that personally identifiable information is removed. For example, a user’s identity may be treated so that no personally identifiable information can be determined for the user, or a user’s geographic location may be generalized where location information is obtained (such as to a city, ZIP code, or state level), so that a particular location of a user cannot be determined. Thus, the user may have control over what information is collected about the user, how that information is used, and what information is provided to the user.

Various implementations of the systems and techniques described here can be realized in digital electronic circuitry, integrated circuitry, specially designed ASICs (application-specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium”, or “non-transitory computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship between client and server arises by virtue of computer programs running on the respective computers and having a client-server relationship with each other.

In this specification and the appended claims, the singular forms "a," "an" and "the" do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent exemplary functional relationships and/or physical or logical couplings between the various elements. Many alternative or additional functional relationships, physical connections or logical connections may be present in a practical device. Moreover, no item or component is essential to the practice of the implementations disclosed herein unless the element is specifically described as “essential” or “critical”.

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, use of terms such as up, down, top, bottom, side, end, front, back, etc. herein are used with reference to a currently considered or illustrated orientation. If they are considered with respect to another orientation, it should be understood that such terms must be correspondingly modified.

Although certain example computer-implemented methods, apparatuses and articles of manufacture have been described herein, the scope of coverage of this patent is not limited thereto. It is to be understood that terminology employed herein is for the purpose of describing particular aspects, and is not intended to be limiting. On the contrary, this patent covers all methods, apparatus and articles of manufacture fairly falling within the scope of the claims of this patent.

In one aspect, a non-transitory computer-readable medium stores instructions that, when executed by a processor on a receiving computing device, causes the receiving computing device to perform any of the methods disclosed herein.

In one aspect, a computing device can be configured with at least one processor and memory storing instructions that, when executed by the at least one processor, perform any of the methods disclosed herein.

The following paragraphs provide various examples of the embodiments disclosed herein.

In one aspect, a wearable device may include a sensor positioned in the wearable device, a processor, and a memory storing instructions that, when executed by the processor, cause the wearable device to perform operations that include receiving sensor data from the sensor; providing the sensor data as input to a DON/DOFF state determination model, executing the DON/DOFF state determination model to generate a determined DON/DOFF state for the wearable device, and determining an operational mode for the wearable device based on the determined DON/DOFF state for the wearable device. The DON/DOFF state determination model is trained to examine historical sensor data and historical user usage data to generate the determined DON/DOFF state for the wearable device.

In one aspect the model is a temporal convolutional neural network. In another aspect the temporal convolutional neural network receives the sensor data for a time window as the input to a first layer of the temporal convolutional neural network and compresses the time window in subsequent layers of the temporal convolutional neural network to reduce a number of layers required for the temporal convolutional neural network. The compression amount of the temporal convolutional neural network is determined based on an amount of processing resources available on the wearable device for executing the DON/DOFF state determination model.

In another example, the model receives time-series sensor data in a sliding time window.

In yet another aspect, the sensor is a proximity sensor.

In an example, the determined DON/DOFF state is one of a DON state, a DOFF state and a none state.

In some examples, the wearable device is one of a head-wearable device, smart watch, earbud or over-ear headphones.

In other examples, the processor is a first processor and the wearable device further includes a second processor, wherein the first processor is configured to execute the DON/DOFF state determination model and the second process is configured to one or more other operations of the wearable device. In an example, the first processor uses less power than the second processor.

In one aspect, a method may be performed that includes receiving sensor data from a sensor positioned in a wearable device, the sensor being configured to provide an indication of the wearable device's position with respect to a user, providing the sensor data as input to a DON/DOFF state determination model of the wearable-device, executing the DON/DOFF state determination model to generate a determined DON/DOFF state for the wearable device, and determining an operational mode for the wearable device based on the determined DON/DOFF state for the wearable device. The DON/DOFF state determination model is trained to examine historical sensor data and historical user usage data to generate the determined DON/DOFF state for the wearable device.

In one example, wherein the sensor is one of a proximity sensor, a capacitive sensor or inertial measurement unit.

In other aspects, the method further includes adjusting the current operational mode of the wearable device to the determined operational mode.

In other examples, the sensor is a first sensor and the method further comprises: receiving second sensor data from a second sensor, and providing the second sensor data as an additional input channel to the DON/DOFF state determination model, wherein the DON/DOFF state determination model generates the determined DON/DOFF state for the wearable device based on the sensor data and the second sensor data.

In some examples, to generate a determined DON/DOFF state for the wearable device includes outputting a 3-node layer that encodes a classification state as one of DOFF, DON or NONE.

In one aspect, a computer readable medium has stored therein instructions that, when executed by a processor, cause the processor to perform functions that include receiving sensor data from a sensor positioned in a wearable device, the sensor being configured to provide an indication of the wearable device's position with respect to a user, providing the sensor data as input to a DON/DOFF state determination model of the wearable-device, executing the DON/DOFF state determination model to generate a determined DON/DOFF state for the wearable device, and determining an operational mode for the wearable device based on the determined DON/DOFF state for the wearable device, wherein the DON/DOFF state determination model is trained to examine historical sensor data and historical user usage data to generate the determined DON/DOFF state for the wearable device.

In other aspects, the DON/DOFF state determination model is a temporal convolutional neural network. In some examples, the temporal convolutional neural network receives the sensor data for a time window as the input to a first layer of the temporal convolutional neural network and compresses the time window in subsequent layers of the temporal convolutional neural network to reduce a number of layers required for the temporal convolutional neural network.

In one aspect, may be performed that includes receiving first data from a first sensor positioned in a wearable device; generating a state, based on a model and the first data, indicating whether the wearable device is being worn; and determining a mode for operating the wearable device based on the state for the wearable device, the model being configured to process second data from a second sensor and usage data to generate the state for the wearable device. The first sensor may be one of a proximity sensor, a capacitive sensor or an inertial measurement unit. The model may be a temporal model. In one aspect, the method further includes adjusting a current mode for operating the wearable device to the mode for operating the wearable device.

In another aspect, the method further includes receiving third data from a third sensor positioned in the wearable device; and providing the third data as an additional input to the model, the model being configured to generate the state for the wearable device based on the first data and the third data.

In some aspects, the model receives the first data for a window of time as an input to a first layer of the model and compresses the window of time in subsequent layers of the model to reduce a number of layers of the model.

In another aspect, to generate the state includes generating an output that classifies the state as one of the wearable device being worn state, the wearable device not being worn state and a none determined state.

In yet another aspect, a wearable device includes a sensor positioned in the wearable device; a processor; and a memory storing instructions that, when executed by the processor, cause the wearable device to perform operations including: generating a state, based on a model and first data from a first sensor, indicating whether the wearable device is being worn; and determining a mode for operating the wearable device based on the state for the wearable device, the model being configured to process second data from a second sensor and usage data to generate the state for the wearable device. In one aspect, the model is a temporal model.

In some aspects, the model receives the first data for a window of time as an input to a first layer of the model and compresses the window of time in subsequent layers of the model to reduce a number of layers of the model.

In an example, an amount of compression for the model is determined based on an amount of resources available on the wearable device for executing the model.

In some examples, the model is stored on the memory of the wearable device. In other examples, the sensor is a proximity sensor.

In some aspects, the state indicating whether the wearable device is being worn is one of a device being worn state, a device not being worn state and a none determined state.

In some examples, the wearable device is one of a head-wearable device, smart watch, earbud or over-ear headphones.

In an example, the processor of the wearable device is a first processor and the wearable device further comprises: a second processor, wherein the first processor is configured to execute the model and the second processor is configured to execute one or more other operations of the wearable device. In some examples, the first processor uses less power than the second processor.

In another aspect, a computer readable medium has stored therein instructions that, when executed by a processor, cause the processor to perform functions that include receiving first data from a first sensor positioned in a wearable device; generating a state, based on a model and the first data, indicating whether the wearable device is being worn; and determining a mode for operating the wearable device based on the state for the wearable device, the model being configured to process second data from a second sensor and usage data to generate the state for the wearable device. In some aspects, the model is a temporal model.

In other aspects, the model receives the first data for a window of time as an input to a first layer of the model and compresses the window of time in subsequent layers of the model to reduce a number of layers of the model.

What is claimed is:

1. A method comprising:
receiving first data from a first sensor included in a wearable device;
generating a state, based on a model and the first data, indicating whether the wearable device is being worn; and
determining a mode for operating the wearable device based on the state for the wearable device,
the model being configured to generate the state for the wearable device based on second data from a second sensor and usage data.

2. The method of claim 1, wherein the model receives the first data for a window of time as an input to a first layer of the model and compresses a dimension of the first data across subsequent layers of the model at a level of compression.

3. The method of claim 2, wherein the level of compression for data representing a recent time period within the window of time is smaller than a level of compression for data representing a time period further from a current time within the window of time.

4. The method of claim 1, wherein to generate the state includes generating an output that classifies the state as one of the wearable device being worn state, the wearable device not being worn state and a none determined state.

5. The method of claim 4, further comprising responsive to classifying the state as a none determined state, increasing a rate of sampling for at least one of the first sensor or the second sensor.

6. The method of claim 1, further comprising:
receiving third data from a third sensor positioned in the wearable device; and
providing the third data as an additional input to the model,
the model being configured to generate the state for the wearable device based on the first data and the third data.

7. The method of claim 1, further comprising adjusting a current mode for operating the wearable device to the mode for operating the wearable device .

8. A wearable device comprising:
a sensor;
a processor; and
a memory storing instructions that, when executed by the processor, cause the wearable device to perform operations including:
generating a state, based on a model and first data from a first sensor, indicating whether the wearable device is being worn; and
determining a mode for operating the wearable device based on the state for the wearable device,
the model being configured to generate the state for the wearable device based on second data from a second sensor or usage data.

9. The wearable device of claim 8, wherein generating the state includes outputting a none state when a level of confidence for the model does not meet a criterion; and in response to the none state, increasing a rate of sampling for the first sensor or the second sensor.

10. The wearable device of claim 8, wherein the model receives the first data for a window of time as an input to a first layer of the model and compresses the window of time in subsequent layers of the model to reduce a number of layers of the model.

11. The wearable device of claim 8, wherein an amount of compression for the model is determined based on an amount of resources available on the wearable device for executing the model.

12. The wearable device of claim 8, wherein the model is stored on the memory.

13. The wearable device of claim 8, wherein the model comprises a neural network having an amount of compression across a plurality of layers, and the amount of compression is derived from a limit of the processor.

14. The wearable device of claim 8, wherein the state is one of a device being worn state, a device not being worn state and a none determined state.

15. The wearable device of claim 8, wherein the wearable device is one of a head-wearable device, smart watch, earbud or over-ear headphones.

16. The wearable device of claim 8, wherein the processor is a first processor and the wearable device further comprises:
a second processor,
wherein the first processor is configured to execute the model and the second processor is configured to execute one or more other operations of the wearable device.

17. The wearable device of claim 16, wherein the first processor uses less power than the second processor.

18. A computer readable medium having stored therein instructions that, when executed by a processor, cause the processor to perform functions comprising:
receiving first data from a first sensor included in a wearable device;
generating a state, based on a model and the first data, indicating whether the wearable device is being worn; and
determining a mode for operating the wearable device based on the state for the wearable device,
the model being configured to generate the state for the wearable device based on second data from a second sensor and usage data.

19. The computer readable medium of claim 18, wherein the model is a temporal model.

20. The computer readable medium of claim 18, wherein the model receives the first data for a window of time as an input to a first layer of the model and compresses the window of time in subsequent layers of the model to reduce a number of layers of the model.
